(19) United States
(12) Patent Application Publication
(10) Pub. No.: US 2026/0074846 A1
(43) Pub. Date: Mar. 12, 2026

(54) UNIFIED TCI STATE ASSOCIATION FOR MULTI-TRANSMISSION RECEPTION POINT BASED COMMUNICATION

(71) Applicant: Apple Inc., Cupertino, CA (US)

(72) Inventors: Hong He, San Jose, CA (US); Dawei Zhang, Saratoga, CA (US); Oghenekome Oteri, San Diego, CA (US); Wei Zeng, Saratoga, CA (US); Haitong Sun, Cupertino, CA (US); Ankit Bhamri, Bad Nauheim (DE); Chunxuan Ye, San Diego, CA (US); Weidong Yang, San Diego, CA (US); Seyed Ali Akbar Fakoorian, San Diego, CA (US)

(21) Appl. No.: 19/105,844

(22) PCT Filed: Sep. 12, 2023
(86) PCT No.: PCT/US23/32462

§ 371 Date: Feb. 24, 2025

Related U.S. Application Data
(60) Provisional application No. 63/408,894, filed on Sep. 22, 2022.

(51) Int. Cl. H04L 5/00; H04L 27/26

(52) U.S. Cl. CPC H04L 5/0044; H04L 27/261

(57) ABSTRACT

Systems, methods, processors, and apparatus are provided for determining a unified TCI state in multi transmission reception communication. In one example, a method for a UE includes receiving a configuration of a plurality of transmission configuration indicator (TCI) states and a unified TCI states activation/deactivation medium access control (MAC) control element (CE) to associate TCI codepoints of a downlink control information (DCI) format to the TCI states, each TCI codepoint indicating one or more TCI states; receiving a first single transmission reception point downlink control information (sDCI) including a TCI codepoint of the plurality of TCI codepoints; receiving a second sDCI that schedules a physical uplink shared channel (PUSCH) transmission, wherein the second sDCI indicates one or more of the TCI states associated with the TCI codepoint of the first sDCI; and in response, transmitting the PUSCH based on the second sDCI.

### REFERENCE TO RELATED APPLICATIONS

This Application claims the benefit of U.S. Provisional Application No. 63/408,894, filed on Sep. 22, 2022, the contents of which are hereby incorporated by reference in their entirety

### BACKGROUND

Multi-transmission reception point (TRP) communication involves a user equipment (UE) exchanging signals with more than one TRP. The multiple TRPs may be integrated into a same base station or different base stations. A UE may communicate with different TRPs using different beams. The data transmitted and received between the UE and the multiple TRPs may be jointly processed to improve reliability, coverage, and capacity performance through flexible deployment scenarios.

### BRIEF DESCRIPTION OF THE DRAWINGS

Some examples of circuits, apparatuses and/or methods will be described in the following by way of example only. In this context, reference will be made to the accompanying figures.

FIG. 1 illustrates a UE communicating with multiple TRPs using multiple beams.

FIG. 2 illustrates an example message sequence for multi-TRP communication configuration and data transmission/reception using unified transmission configuration indicator (TCI) states, in accordance with various aspects described.

FIG. 3 illustrates an example of multi-TRP communication using unified TCI states, in accordance with various aspects described.

FIG. 4 illustrates an example message sequence for multi-TRP communication configuration and data reception during a quasi co-location (QCL) window, in accordance with various aspects described.

FIG. 5A illustrates two power control (PC) setting lists, in accordance with various aspects described.

FIG. 5B illustrates a PC setting list, in accordance with various aspects described.

FIG. 6 illustrates an example message sequence for multi-TRP communication configuration and data transmission when PC settings are not previously configured, in accordance with various aspects described.

FIG. 7 illustrates an example of multi-TRP communication using unified TCI states based on fallback downlink control information (DCI), in accordance with various aspects described.

FIG. 8 illustrates an example message sequence for multi-TRP or single-TRP communication using unified TCI states based on fallback downlink control information (DCI), in accordance with various aspects described.

FIG. 9 illustrates an example of multi-TRP configuration using unified TCI states during transition from multi-TRP to single-TRP operation, in accordance with various aspects described.

FIG. 10 illustrates an example message sequence for multi-TRP or single-TRP communication using unified TCI states, in accordance with various aspects described.

FIG. 11 illustrates an example of multi-TRP uplink configuration and data transmission using unified TCI states based on dynamic grant, in accordance with various aspects described.

FIG. 12 illustrates an example message sequence for multi-TRP uplink configuration and data transmission using unified TCI states based on dynamic grant, in accordance with various aspects described.

FIG. 13 is a diagram of an example network according to one or more implementations described herein.

FIG. 14 illustrates a simplified block diagram of a user equipment wireless communication device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

### Unified Beam Management Overview

As the focus of wireless communication moves toward higher frequencies, beamforming has become an important aspect of the operation of wireless communication devices. In downlink, beams are defined by transmission configuration indicator (TCI) states. A TCI state includes a source reference signal (e.g., a channel state information reference signal (CSI-RS) or synchronization signal block (SSB)) and an intended quasi-co-location (QCL) type to be applied. Downlink control information (DCI) scheduling downlink data indicates one or more TCI state(s) for receiving the signal encoding the data. To receive a signal based on an indicated TCI state(s), the UE sets its beamforming coefficients based on the reference signal(s) and QCL type(s) in the TCI state(s). In uplink, beams are indicated by distinct spatial domain transmission filters. In DCI scheduling uplink data, a spatial domain transmission filter is identified by a sounding reference signal resource indicator (SRI). To transmit a signal based on an indicated SRI, the UE sets its beamforming coefficients based on the sounding reference signal (SRS) associated with the SRI.

Early LTE and NR releases supported configuration of separate beams for control channels (e.g., physical uplink control channel (PUCCH) and physical downlink control channel (PDCCH) and data channels (e.g., physical uplink shared channel (PUSCH) and physical downlink shared channel (PDSCH)). However, due to the signaling overhead needed for such granular beam configuration, later releases optimized support for common beam management. In common beam management, certain beams may be configured for more than one channel or signal, including control and data signals in either UL, DL, or both UL and DL as well as CSI-RS and SRS. This reduces the signaling overhead because a single TCI state configuration may cover multiple channels and/or reference signals. A beam may be referred to herein in relation to a unified TCI state in both UL and DL. For the purposes of this disclosure, the terms TCI state, and unified TCI state may be used interchangeably. The term beam may be used as a shorthand reference to UE or base station settings that are used to transmit or receive data based on information associated with a corresponding or associated TCI state.

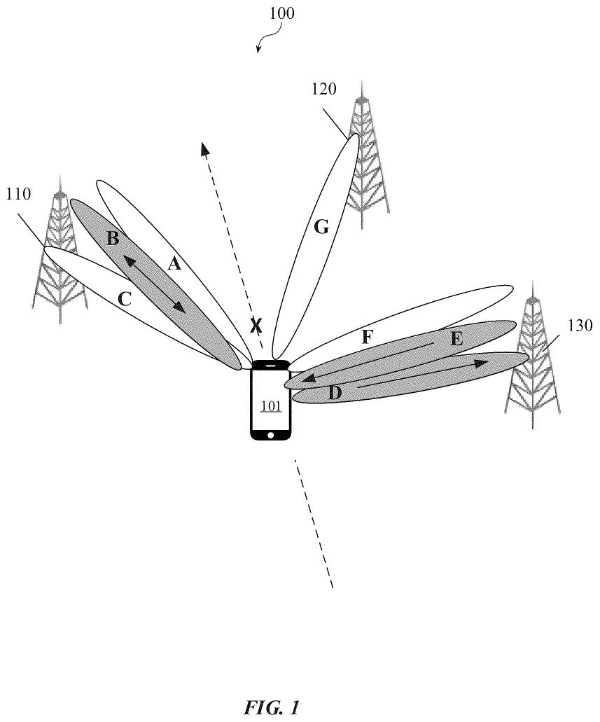

Referring now to FIG. 1, a wireless communication network 100 is illustrated that includes UE 101 and three base stations 110, 120, 130. The UE 101 moves through the network 100 along the dashed line path in the direction indicated by the arrow. The UE 101 is configured for multi-transmission reception point (TRP) communication in which the UE transmits/receives control and/or user data with respect to more than one TRP. The signals exchanged between the UE and the different TRPs may be separated in frequency, time, or spatial layer. Each base station may include multiple TRPs (e.g., antenna arrays), with the different TRPs each providing multiple different TX/RX beams.

In the illustrated example, TCI states A-G have been activated for the UE 101. The number of beams that may be activated for a UE is based on the UE's beamforming capability. Beams A, B, C, F, and G are joint unified TCI states that are configured for both uplink and downlink. Beam D is an UL unified TCI state and beam E is a DL unified TCI state. Based on DCI that indicates TCI states for associated data transmission/reception, the UE 101 transmits and receives signals (e.g., PUCCH, PUSCH, PDCCH, PDSCH, CSI-RS, and/or SRS) to/from a first TRP on base station 110 using TCI state B, receives signals (e.g., PDCCH, PDSCH, and/or CSI-RS) from a second TRP on base station 130 using beam E, and transmits signals (e.g., PUCCH, PUSCH, and/or SRS) to the second TRP on base station 130 using beam D. As network or channel conditions change or as the UE moves with respect to the base stations different TCI states from amongst the activated TCI states A-G may be indicated by subsequent DCI to optimize the quality of the communication link.

To simplify signaling, TCI states may be grouped into pairs of TCI states with each TCI state in the pair corresponding to a different TCI state, possibly associated with different TRPs. The network may map codepoints to single pair of TCI states (for single TRP) or two pairs of TCI states (for multi-TRP), each pair including one DL unified TCI state and one UL unified TCI state or, alternatively, a joint unified TCI state. The DCI may then use a single codepoint to indicate either one pair or two pairs of TCI states should be applied. In FIG. 1, a single codepoint could indicate that the UE 101 is to use TCI state B and TCI state D for uplink toward two TRPs, respectively, and a single codepoint could indicate that the UE 101 is to use TCI state B and TCI state E for downlink from two TRPs, respectively. Subsequently, when the UE 101 reaches point X on the UE path, DCI could use a different codepoint to indicate that the UE 101 is to use TCI state B and TCI state G for either uplink or downlink or both directions. When the UE is to switch to single TRP communication, the DCI may use a codepoint that indicates a single TCI state (commonly applied for both DL and UL) or a single pair of TCI states (one for DL and the other for UL) of the TCI states A-G for communication.

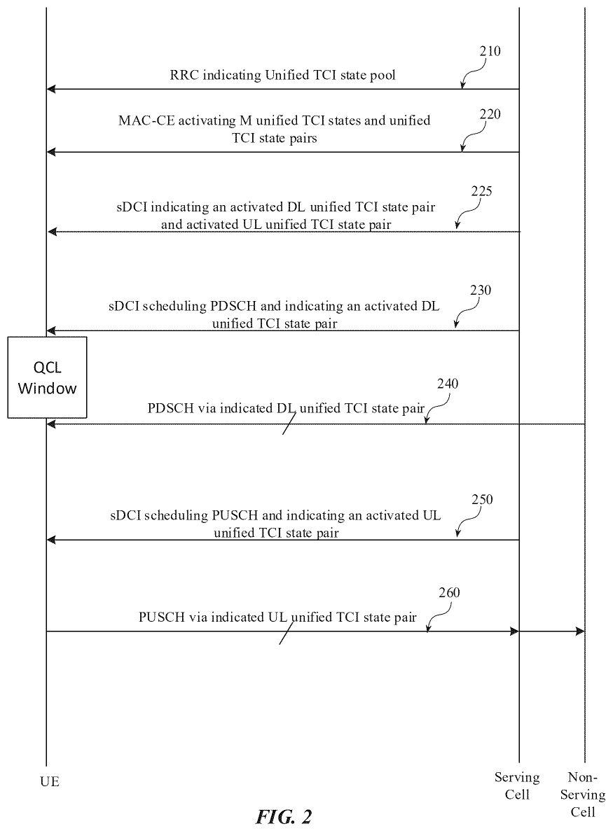

FIG. 2 is a message flow diagram outlining an example of multi-TRP communication. At 210, a first TRP associated with a base station (e.g., serving cell) transmits radio resource control (RRC) signaling that configures a TCI state pool or list that includes a plurality of unified TCI states. The unified TCI states may each be configured for a plurality of channels and/or signals, such as both data and control channels as well as reference signals. Some of the indicated unified TCI states may be joint unified TCI states that are configured for both uplink and downlink channels and/or signals. At 220, the base station transmits a medium access control (MAC) control element (CE) that activates up to M combinations (e.g., 8, depending on UE capability) of the indicated unified TCI states, where each combination includes a single pair of single unified TCI states (for single TRP) or unified TCI state pairs (for multi-TRP). The MAC CE may map the different combinations (including either a single pair of unified TCI states or two pairs of unified TCI states) to different TCI codepoints. The TCI codepoint in a DCI format is further used to dynamically select one from the up to ‘M’ activated unified TCI state combinations.

In multi-TRP communication there are two types of scheduling schemes: single DCI (sDCI) scheme and multiple DCI (mDCI) scheme. In the sDCI scheme, a single sDCI can schedule PUSCH/PDSCH for two TRPs while in the mDCI scheme, two DCIs are used with each respective DCI scheduling PUSCH/PDSCH for a single respective TRP. Thus, with mDCI, separate DCI signaling is used to configure PUSCH/PDSCH for each TRP, while with sDCI a single message schedules PUSCH/PDSCH for multiple TRPs. In the example of FIG. 2, sDCI is used. At 225, the base station sends an sDCI that indicates (e.g., by codepoint) a DL unified TCI state pair and an UL unified TCI state pair. The unified TCI state combination indicated by the TCI codepoint in the sDCI in 225 may include one or more DL unified TCI states, one or more UL unified TCI states, and/or one or more joint (e.g., both UL and DL) TCI states. At 230, the base station sends sDCI scheduling a data reception (e.g., PDSCH) for the UE.

After a QCL window expires, at 240 the base station transmits the PDSCH and the UE uses the indicated DL unified TCI state pair to receive the scheduled PDSCH. The QCL window represents the time it takes the UE to decode the sDCI and tune its transmitters to the indicated DL unified TCI state(s). In one example, the UE signals its capability to the network in terms of a number of symbols (e.g., 28 symbols or two slots) and the duration of the QCL window is assumed by the network based on the UE's signaled capability. In one example, the UE uses information element (IE) timeDurationforQCL to signal its decoding/tuning capability to the network.

At 250, the base station sends sDCI scheduling an uplink data transmission (e.g., PUSCH) from the UE to the base station. At 260 the UE uses the indicated UL unified TCI state pair (e.g., in message 225) to transmit the PUSCH.

As the UE moves through the coverage area or network/channel conditions change, different unified TCI states or unified TCI state pairs may be activated as per 220. A different unified TCI state pool may also be indicated by subsequent RRC signaling as per 101 in response to more significant change in the UE's position or channel/network conditions.

Several open issues remain regarding common beam management for multi-TRP scenarios including determining default TCI state(s) PDSCH during the QCL window, determining default UE power settings when not configured by active TCI state, determining an assumed TCI state when PDSCH/PUSCH is scheduled by fallback DCI without a TCI field, how to support dynamic switching between sTRP and mTRP operation, and determining a TCI state for a dynamic grant (DG)-PUSCH for sDCI. Described herein are techniques for extending the unified TCI framework to address these and other issues.

### TCI State During QCL Window

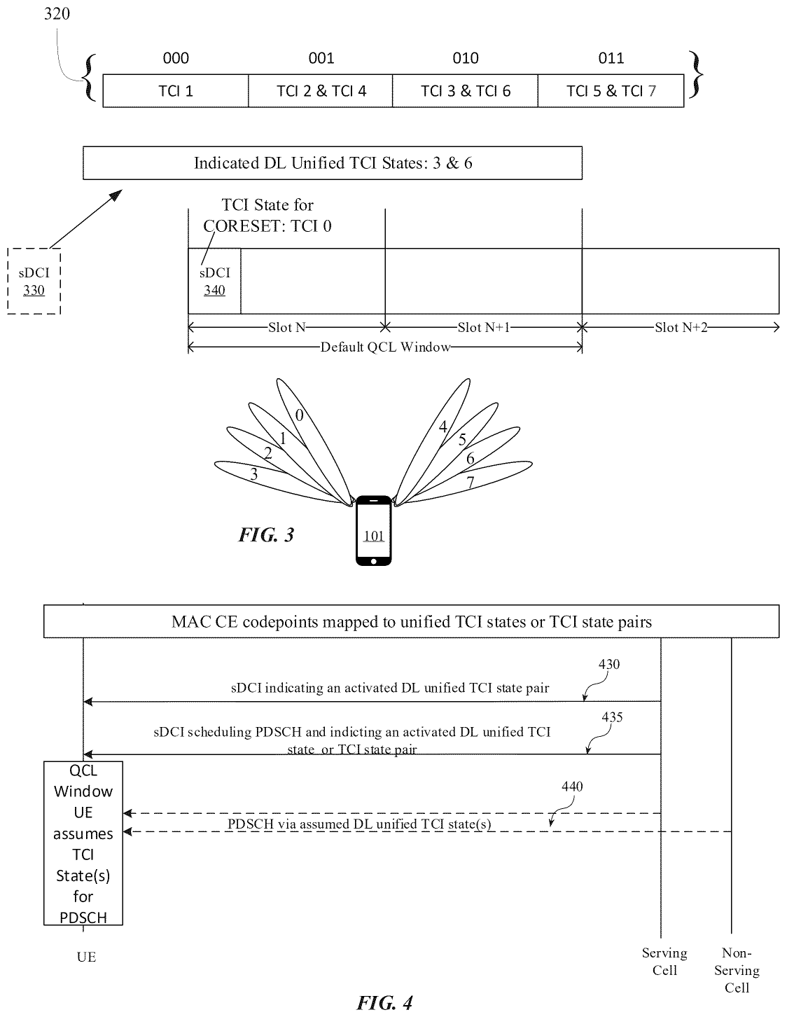

FIGS. 3 and 4 illustrate an example multi-TRP communication configuration and downlink data reception scenario. It is assumed that a TCI state pool or list including multiple unified TCI states has already been allocated to the UE 101. As shown in FIG. 3, a MAC CE 320 is received that includes a set of activated unified TCI states selected from the TCI state pool and four TCI state combinations are associated with four codepoints 000, 001, 010, 011. Codepoint 000 corresponds to TCI state 1 (see beam 1 indicated in FIG. 3) and configures single-TRP communication. Codepoints 001 and 010 each configure two TCI states for multi-TRP communication with a serving cell and a non-serving cell. Codepoint 001 configures beam 2 for the serving cell and beam 4 for the non-serving cell while codepoint 010 configures beam 3 for the serving cell and beam 6 for the non-serving cell. Codepoint 011 configures two beams for the non-serving cell, beams 5 and 7. A first sDCI 330 is received that indicates unified TCI states 3 and 6 for downlink data reception (e.g., by using TCI codepoint 010 in sDCI 330). The TCI states indicated by a most recent sDCI are referred to herein as the currently indicated TCI states.

A second sDCI 340 is received using a beam associated with a TCI state 0 which was assumed to be separately configured for this CORESET. Note that the TCI state of CORESET may follow one of the active TCI states (i.e., TCI state 3). Ambiguity may arise as to what TCI state(s) should be used by the UE to receive/buffer PDSCH during the QCL window.

FIG. 4 is a message flow diagram outlining the scenario of FIG. 3. As described with respect to FIG. 3, the UE has already received configuration of a plurality TCI codepoints (e.g., 000,001,010,011 of FIG. 3). At least two of the plurality of TCI codepoints are each mapped to two different TCI states and each TCI state is identified by a TCI state identifier (ID). At 430, the UE receives a first sDCI indicating an activated DL TCI state pair using a TCI codepoint of the plurality of TCI codepoints that indicates two TCI states, the indicated two TCI states including a first TCI state and a second TCI state (e.g., codepoint 010 indicating TCI state 3 and TCI state 6). At 435, based on a third TCI state (e.g., TCI state 0 of FIG. 4), the UE receives a second sDCI (e.g., sDCI 340 of FIG. 4) scheduling PDSCH reception. During a predetermined window after time at which the sDCI 340 is received (e.g., the QCL window), the UE assumes one or more TCI states for PDSCH reception based on the configuration of the plurality of TCI codepoints of the MAC CE or the third TCI state. At 440 the UE receives PDSCH via the assumed TCI state(s).

There a several approaches the UE may use to assume the TCI state(s) for PDSCH reception during the QCL window when there are two currently indicated DL unified TCI states. Some example options are disclosed with reference to the example shown in FIGS. 3 and 4 in which the currently indicated TCI states are TCI states 3 and 6 as configured by first sDCI 330. In other examples the currently indicated TCI states may have been indicated in a previously received sDCI or another communication or configuration.

In a first approach, the UE assumes the currently indicated TCI states or beam 3 and beam 6 in the example of FIGS. 3 and 4.

In a second approach, the UE assumes the two TCI states indicated by a lowest indicated TCI codepoint of the plurality of TCI codepoints that indicates two TCI states. In the illustrated example, the UE would assume beam 2 and beam 4 (for codepoint 001).

In a third approach, the UE assumes the TCI state associated with the CORESET with a monitored search space with the lowest CORESET ID in the latest slot in which one or more CORESETSs are monitored by the UE. In the illustrated example, this TCI state is the third TCI state, TCI state 0 which is used to receive sDCI 340. In an example of this approach, the UE assumes the third TCI state during the QCL window when a physical cell identifier (PCI) associated with the two TCI states indicated by the codepoint included in the first sDCI are associated with a neighbor cell that is different from a serving cell of the UE (e.g., if codepoint 011 had been included in sDCI 330 rather than codepoint 010). In this manner, the UE may have a better beam for receiving the data transmission as compared to a beam associated with a non-serving cell.

In a fourth approach, the UE assumes one of the two currently indicated TCI states, or TCI state 3 or 6 of the illustrated example. In a first example of this approach a TCI state of the two currently indicated TCI states having a smallest TCI ID is assumed (e.g., TCI state 3 in the illustrated example). In a second example of this approach a TCI state of the two currently indicated TCI states having a largest TCI ID is assumed (e.g., TCI state 6 in the illustrated example). In a third example of this approach, the UE assumes a TCI state of the two currently indicated TCI states that is configured with quasi-co-location (QCL)-Type A/D source reference signal (RS) on a downlink (DL) bandwidth part (BWP) of a serving cell (e.g., TCI state 3 in the illustrated example). In a fourth example of this approach, the UE assumes one of the two TCI states based on higher layers signaling (e.g., that configures either a first or second of the two currently indicated TCI states (e.g., TCI state 3 (first) or TCI state 6 (second) in the illustrated example)).

### Default Power Control Parameters

Flexible configuration of power control parameters may be support improved multi-TRP communication. For example, as a UE communicating with a first TRP and a second TRP moves toward the first TRP and away from the second TPR, it may be beneficial to decrease the transmission power of the UE on the beam associated with the first TRP and increase the transmission power on the beam associated with the second TRP. Power control parameters include ‘P0, alpha for PUSCH, close loop index I, and so on.

Depending on configuration, certain power control parameters for uplink transmission may not be associated with some unified TCI states, leading to ambiguity as to what power control parameter values should be used. To address this ambiguity one or more power control (PC) setting lists may be configured. In one example, the PC setting lists may be configured in a bandwidth part (BWP) UL dedicated information element. Each entry (e.g., addressed by an index value) in a PC setting list may be mapped to a unique set of power control parameter values. When one or more of an indicated joint or UL TCI state is not configured with PC parameter settings, the UE may apply a preconfigured or explicitly configured index or entry of the PC setting list as a default PC setting for transmitting to a TRP.

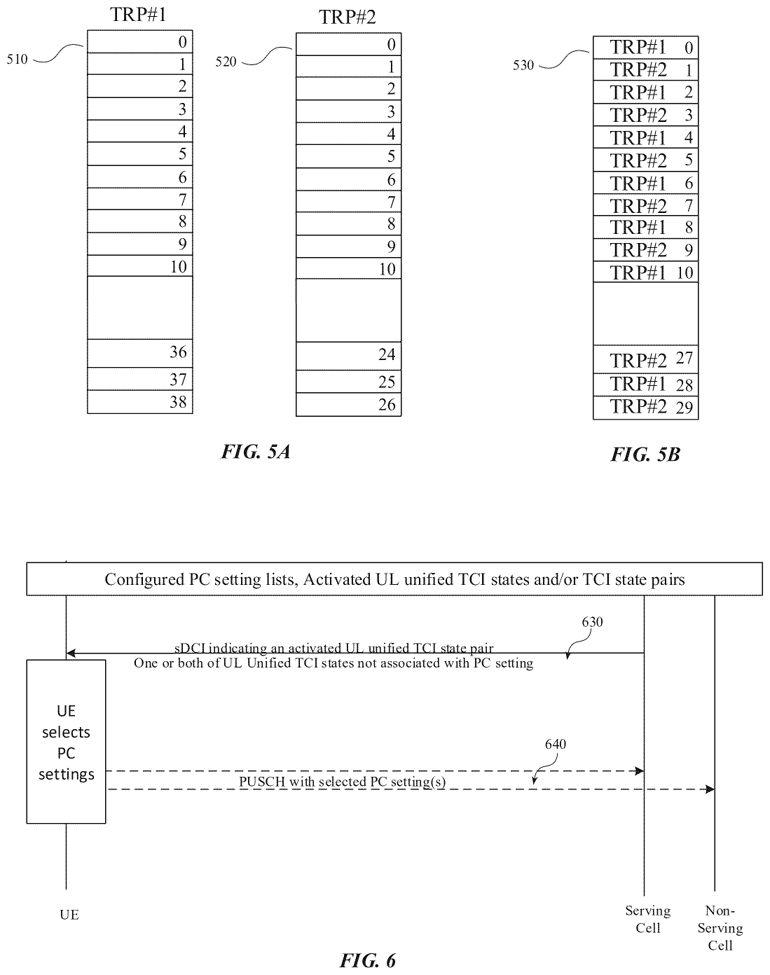

FIGS. 5A and 5B illustrate two different example approaches to PC setting lists. In FIG. 5A, a PC setting list is configured for each TRP and PC setting list 510 is associated with TRP #1 and PC setting list 520 is associated with TRP #2. In FIG. 5B, a PC setting list 530 includes entries for multiple TRPs in an alternating fashion.

FIG. 6 is a message flow diagram outlining an example of a UE applying default PC parameter settings based on PC setting list(s). The UE is assumed to have received a configuration of one or more PC setting lists. Each entry in each of the PC setting lists is associated with one or more TRPs. The UE has also received a configuration of a plurality of TCI codepoints, each TCI codepoint indicating one or more activated UL TCI states. At 630 the UE receives sDCI scheduling physical uplink shared channel (PUSCH) transmission, wherein the sDCI includes a TCI codepoint of the indicated TCI codepoints indicating two TCI states. In response to one or both of the two UL TCI states not being associated with a power control setting, at 640 the UE transmits the PUSCH based on one or more PC settings mapped to PC setting list entries selected from the respective one or more PC setting lists.

There a multiple approaches to which PC setting list entry is selected by the UE to determine PC setting parameter values for the PUSCH. In a first approach, the UE applies PC setting parameters mapped to a PC setting list entry having a lowest index value of respective PC settings associated with each of the two TRPs. In the illustrated example, for the beam associated with TRP #1 the UE would select PC setting values mapped to entry 0 of PC setting list 510 and for the beam associated with TRP #2 the UE would select PC setting values mapped to entry 0 of PC setting list 520. If the PC setting list 530 were used, for the beam associated with TRP #1 the UE would select PC setting values mapped to entry 0 of PC setting list 530 and for the beam associated with TRP #2 the UE would select PC setting values mapped to entry 1 of PC setting list 530.

In a second approach, the UE applies PC setting parameters mapped to a PC setting list entry having a pre-configured index value of respective PC settings associated with each of the two TRPs. In the illustrated example, assuming a pre-configured value of 1 for TRP #1 and a pre-configured index value of 2 for TRP #2, for the beam associated with TRP #1 the UE would select PC setting values mapped to entry 1 of PC setting list 510 and for the beam associated with TRP #2 the UE would select PC setting values mapped to entry 2 of PC setting list 520. If the PC setting list 530 were used, for the beam associated with TRP #1 the UE would select PC setting values mapped to entry 2 of PC setting list 530 and for the beam associated with TRP #2 the UE would select PC setting values mapped to entry 5 of PC setting list 530.

In a third approach, the UE applies PC settings mapped to a PC setting list entry on a PC setting list associated with a selected one of the different TRPs. In the illustrated example, either PC setting list 510 or 520 of FIG. 5A would be used by the UE. In one example of this approach, the UE applies PC settings mapped to a PC setting list entry having a lowest identifier on the PC setting list associated with the selected one of the different TRPs. In this example, if TRP #1 is the selected TRP (e.g., TRP #1 is associated with a serving cell), entry 0 of PC setting list 510 would be used.

### TCI State When Fallback DCI Schedules PUSCH/PDSCH

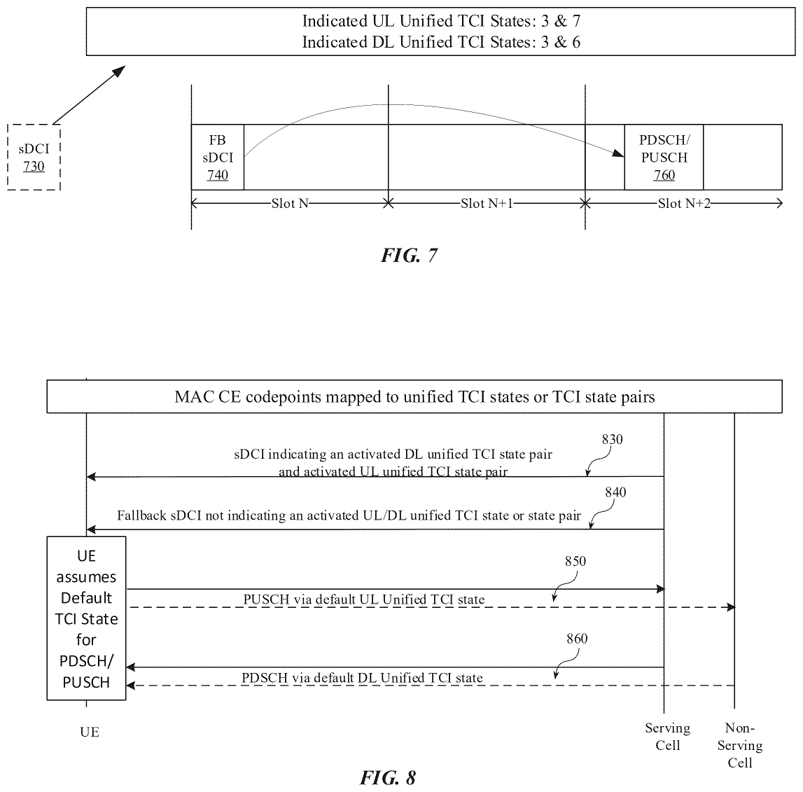

Fallback DCI is DCI that includes a reduced number of bits or fields. Fallback DCI scheduling PUSCH or PDSCH may not include TCI state information. This leads to ambiguity as to what beam the UE should use to transmit/receive the scheduled data transmission. FIGS. 7 and 8 illustrate an example multi-TRP communication configuration and uplink/downlink data transmission/reception scenario. For the example, it is assumed that a TCI state pool or list including multiple unified TCI states has already been allocated to the UE. It is also assumed that a MAC CE was received that includes a set of activated unified TCI states selected from the TCI state pool and a plurality of TCI state combinations that are each associated with a TCI codepoint. As shown in FIG. 7, an sDCI 730 was previously received that indicates UL unified TCI states 3 and 7 for uplink data transmission and DL unified TCI states 3 and 6 for downlink data reception. At 740, fallback DCI is received that schedules either PUSCH or PDSCH 760. The fallback DCI does not indicate unified TCI states for the PUSCH/PDSCH. Ambiguity may arise as to what TCI state(s) should be used by the UE to transmit/receive PUSCH/PDSCH 760 that is scheduled by fallback DCI.

FIG. 8 is a message flow diagram outlining the scenario of FIG. 7. As described with respect to FIG. 7, the UE has received a configuration of a plurality of TCI codepoints, each TCI codepoint indicating one or more activated UL unified TCI states or DL unified TCI states or joint unified TCI states.

In the uplink scenario, at 830 the UE receives sDCI indicating two UL unified TCI states (e.g., sDCI 730 and TCI states 3 and 7 in FIG. 7). At 840, the UE receives subsequent fallback sDCI configuring PUSCH transmission. The fallback sDCI does not indicate UL unified TCI states for the PUSCH (e.g., the sDCI does not include a TCI codepoint). In response to the fallback sDCI the UE assumes a default TCI state for the PUSCH. In this example a single TCI state is assumed (single-TRP) for transmitting PUSCH in response to fallback DCI. This may be desirable when fallback DCI is used in situations where beam qualities may be degraded. At 850 the UE transmits PUSCH based on the assumed default UL unified TCI state. In other examples, two default UL unified TCI states are assumed and the UE transmits using two beams.

In the downlink scenario, at 830 the UE receives sDCI indicating two DL unified TCI states (e.g., sDCI 730 and TCI states 3 and 6 in FIG. 7). At 840, the UE receives subsequent fallback sDCI configuring PDSCH transmission. The fallback sDCI does not indicate DL unified TCI states for the PDSCH (e.g., the sDCI does not include a TCI codepoint). In response to the fallback sDCI the UE assumes a default TCI state for the PDSCH. In this example a single TCI state is assumed (single-TRP) for receiving PDSCH in response to fallback DCI. This may be desirable when fallback DCI is used in situations where beam qualities may be degraded. At 860 the UE receives PDSCH based on the assumed default DL unified TCI state. In other examples, two default DL unified TCI states are assumed and the UE receives using two beams.

There are several approaches for determining which unified TCI state the UE assumes for transmitting PUSCH or receiving PDSCH that is scheduled by fallback DCI. In a first approach, a default UL unified TCI state and/or default DL unified TCI state is hard-encoded in the UE or predefined by specification and stored in hardware of the one or more processors of the UE.

In another example, the default unified TCI state is based on an indication of either a first TCI state, a second TCI state, or both TCI states of two currently indicated uplink TCI states (e.g., TCI states 3 and 7 in FIG. 7) or two currently indicated downlink TCI states (e.g., TCI states 3 and 6 in FIG. 7) hard-encoded in the UE or predefined by specification and stored in hardware of the one or more processors of the UE. Thus, in FIG. 7 if an indication of “second TCI state” was hard encoded in UE then UL unified TCI state 7 would be used to transmit PUSCH in response to fallback sDCI and DL unified TCI state 6 would be used to receive PDSCH in response to fallback sDCI.

In another example, the default unified TCI state is explicitly configured by RRC signaling, a MAC CE, or a DCI. The default TCI state may be indicated by TCI ID or as either a first TCI state, a second TCI state, or both TCI states of two currently indicated uplink TCI states (e.g., TCI states 3 and 7 in FIG. 7). Thus, in FIG. 3 if RRC signaling indicated that the default beams should be “both TCI states” then UL unified TCI states 3 and 7 would be used to transmit PUSCH in response to fallback sDCI and DL unified TCI states 3 and 6 would be used to receive PDSCH in response to fallback sDCI.

### PUCCH/PDCCH Configuration for Dynamic Switching Between Single-TRP and Multi-TRP

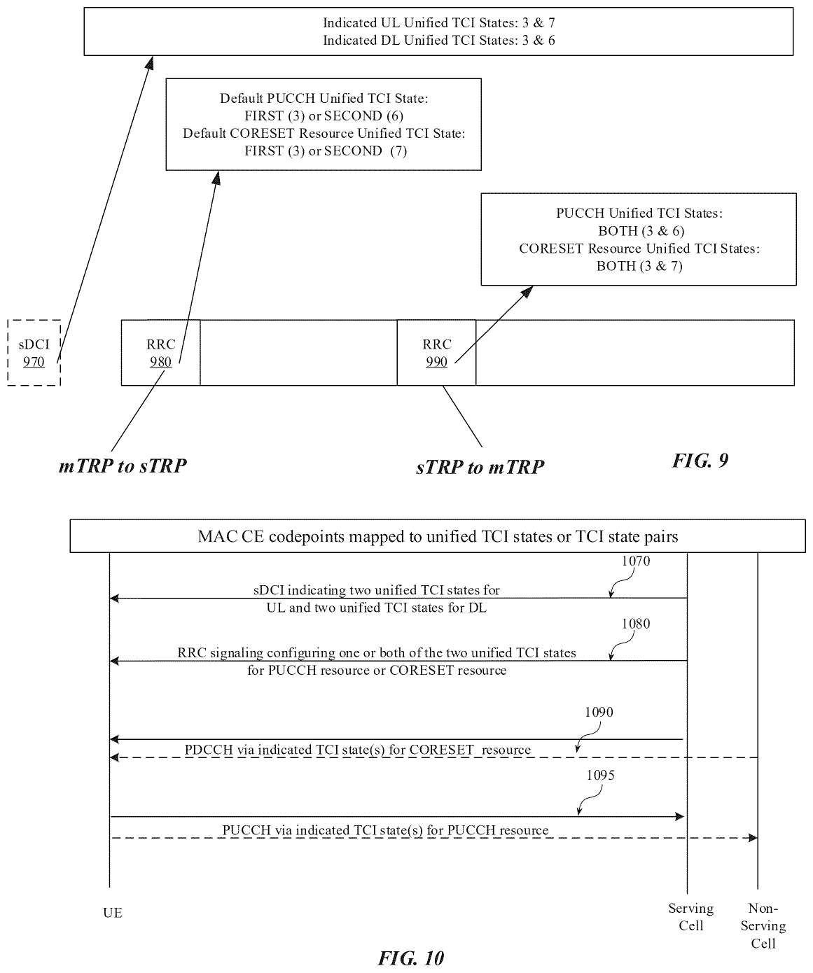

A UE may be switched between multi-TRP and single-TRP operation as the UE moves through a network or channel or network conditions change. Thus mechanisms should be provided for configuring unified TCI states for PUCCH and PDCCH dynamically as the UE transitions between modes. FIGS. 9 and 10 illustrate a scenario in which a UE transitions from multi-TRP to single-TRP and then back to multi-TRP.

In FIG. 9 there are two currently indicated UL unified TCI states, unified TCI state 3 and unified TCI state 7, which are applied for a PUCCH resource which is configured by RRC signaling, and two currently indicated unified DL TCI states, unified TCI state 3 and unified TCI state 6, which are applied for a CORESET resource (e.g., PDCCH) which is configured by RRC signaling. The currently configured TCI states were indicated by previously received DCI 970. In one example, when the UE switches from multi-TRP to single-TRP, RRC signaling 980 indicates which of the two indicated unified TCI states should be used for PUCCH transmission or CORESET resource reception during single-TRP operation. The RRC signaling indicates either a first or a second of the currently indicated TCI states. When the UE switches from single-TRP to multi-TRP, RRC signaling 990 indicates that both currently indicated unified TCI states for PUCCH and CORESET resource reception should be used for multi-TRP operation. When the RRC signaling configures both TCI states (e.g., multi-TRP operation), PUCCH repetition or SFN-based PDCCH or PDCCH repetition may be implicitly enabled. The RRC signaling may include two bits that signal either first, second, or both unified TCI states on a per PUCCH and CORESET resource basis.

FIG. 10 is a message flow diagram outlining an example of the scenario of FIG. 9. For the example, it is assumed that a TCI state pool or list including multiple unified TCI states has already been allocated to a UE that may operate in a single-TRP or a multi-TRP mode. It is also assumed that a MAC CE was received that includes a set of activated unified TCI states selected from the TCI state pool and a plurality of TCI state combinations that are each associated with a TCI codepoint. At 1070 the UE receives a DCI indicating two unified TCI states for uplink (including PUCCH) and two unified TCI states for downlink (including CORESET resource). At 1080, the UE receives RRC signaling indicating whether a first unified TCI state, a second unified TCI state, or both of the currently indicated TCI states should be used for PUCCH transmission and CORESET resource reception. For example, the RRC signaling at 1080 may indicate the first TCI state for PUCCH and both TCI states for CORESET resource. At 1090, the UE receives PDCCH via the indicated unified TCI state(s). In the example, the UE receives PDCCH using beam 3 and beam 6. At 1095 the UE transmits PUCCH via the indicated unified TCI state. In the example, the UE transmits PUCCH using beam 3.

### TCI State Mapping for Dynamic Grant PUSCH

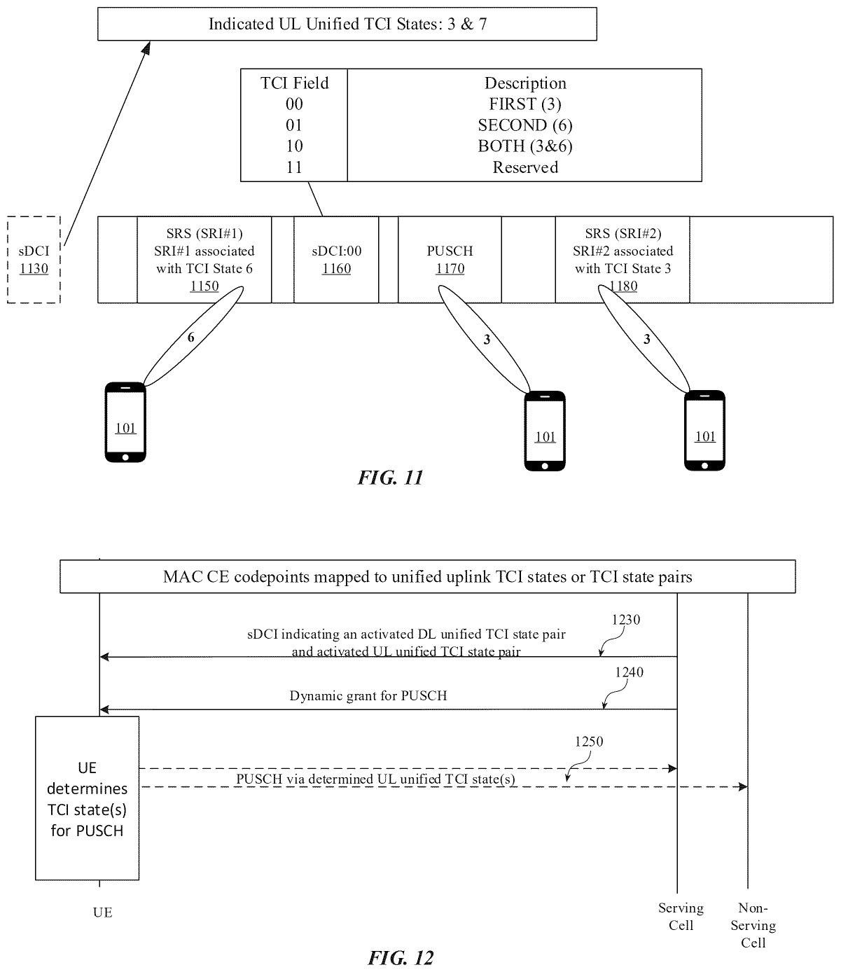

Dynamic grant based PUSCH (as distinguished from configured grant based PUSCH) is scheduled by particular DCI formats. Existing dynamic grant PUSCH scheduling DCI formats may be extended or modified to support multi-TRP operation with UL unified TCI states. FIGS. 11 and 12 illustrate an example multi-TRP communication configuration and dynamic grant PUSCH transmission scenario. For the example, it is assumed that a TCI state pool including multiple UL unified TCI states has already been allocated to the UE 101 and a subset of the UL unified TCI states has been activated for the UE. As shown in FIG. 11, an sDCI 1130 was previously received that indicates UL unified TCI states 3 and 7 for uplink data transmission. At 1150 the UE transmits an SRS using UL unified TCI state 6, which has previously been associated with the SRI #1. At 1160, dynamic grant sDCI is received that schedules PUSCH 1170.

FIG. 12 is a message flow diagram outlining the scenario of FIG. 11. For the example, it is assumed that a TCI state pool or list including multiple unified TCI states has already been allocated to the UE. It is also assumed that a MAC CE was received that includes a set of activated unified TCI states selected from the TCI state pool and a plurality of TCI state combinations that are each associated with a TCI codepoint. At 1230 the UE receives a first sDCI indicating two UL unified TCI states (e.g., TCI states 3 and 7 in FIG. 7). At 1240, the UE receives a second, dynamic grant, sDCI configuring PUSCH transmission. The UE determines UL unified TCI state(s) for transmitting the PUSCH. At 1250 the UE transmits PUSCH based on the determined UL unified TCI state(s).

There are several approaches to how the UE determines the UL unified TCI state(s) for dynamic grant based PUSCH. In a first approach, the dynamic grant PUSCH scheduling DCI (e.g., sDCI 1160) may be modified or extended to indicate which of the currently indicated UL unified TCI states (e.g. TCI states 3 and 7 in FIG. 11) should be used for the PUSCH. In one example of this approach, the dynamic grant PUSCH scheduling DCI includes a field that indicates one of at least three values, where a first value corresponds to a first TCI state of two currently indicated uplink TCI states, a second value corresponds to a second TCI state of the two currently indicated uplink TCI states, and a third value corresponds to both TCI states of the two currently indicated uplink TCI states. In one example the field corresponds to dedicated bits of the dynamic grant (e.g., an existing dynamic grant PUSCH scheduling DCI format is extended to include a new field). In another example, the field is SRI field of the dynamic grant PUSCH scheduling DCI. In the example of FIG. 11, if the sDCI 1160 includes 00 in a TCI field (either a new field or the current SRI field) to indicate that the first of the currently indicated UL unified TCI states should be used for the PUSCH. In response, the UE transmits PUSCH 1170 using beam 3 which is the first of the currently indicated UL unified TCI states.

In a second approach, the dynamic grant PUSCH scheduling DCI does not explicitly indicate UL unified TCI state(s) for the PUSCH. In one example of this approach, the UE selects a spatial domain transmission filter associated with a most recent SRI for transmitting the PUSCH. In the example of FIG. 11 in this case (not shown) the UE would use beam 6 which was used to transmit SRS 1150. After transmitting PUSCH 1170 the UE may transmit subsequent SRS 1180 using SRI #2 which is associated with unified UL TCI state 3.

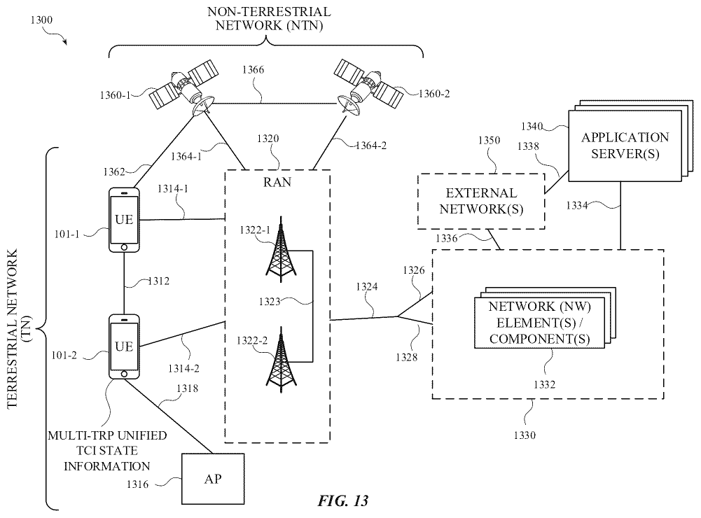

FIG. 13 is an example network 1300 according to one or more implementations described herein. Example network 1300 may include UEs 101-1, 101-2, etc. (referred to collectively as “UEs 101” and individually as “UE 101”), a radio access network (RAN) 1320, a core network (CN) 1330, application servers 1340, external networks 1350, satellites 1360-1, 1360-2, etc. (referred to collectively as “satellites 1360” and individually as “satellite 1360”). As shown, network 1300 may include a non-terrestrial network (NTN) comprising one or more satellites 1360 (e.g., of a global navigation satellite system (GNSS)) in communication with UEs 101 and RAN 1320.

The systems and devices of example network 1300 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 1300 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), Etc.), and more.

As shown, UEs 101 may include smartphones (e.g., handheld touchscreen mobile computing devices connectable to one or more wireless communication networks). Additionally, or alternatively, UEs 101 may include other types of mobile or non-mobile computing devices capable of wireless communications, such as personal data assistants (PDAs), pagers, laptop computers, desktop computers, wireless handsets, etc. In some implementations, UEs 101 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 101 may communicate and establish a connection with one or more other UEs 101 via one or more wireless channels 1312, each of which may comprise a physical communications interface/layer. The connection may include an M2M connection, MTC connection, D2D connection, etc. In some implementations, UEs 101 may be configured to discover one another, negotiate wireless resources between one another, and establish connections between one another, without intervention or communications involving RAN node 1322 or another type of network node. In some implementations, discovery, authentication, resource negotiation, registration, etc., may involve communications with RAN node 1322 or another type of network node.

UEs 101 may communicate and establish a connection with (e.g., be communicatively coupled) with RAN 1320, which may involve one or more wireless channels 1314-1 and 1314-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 1322-1 and 1322-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 1330. Additionally, at least one of the MN or the SN may be operated with shared spectrum channel access, and functions specified for UE 1310 can be used for an integrated access and backhaul mobile termination (IAB-MT). Similar for UE 1310, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 1322.

As described herein, a UE 101-2 may operate in multi-TRP mode in which the UE is simultaneously communicating with multiple transmission reception points (TRPs) (e.g., a TRP associated with network node 1322-1 and a TRP associated with network node 1322-2) in channel 1314-2 using multiple unified TCI states. The UE 101-2 is configured to receive, store, and process multi-TRP unified TCI state information that causes the UE 101-2 to perform functions described above with respect to common beam management for multi-TRP operation. The multi-TRP unified TCI state information may include instructions or algorithms used by the UE for determining default TCI state(s) PDSCH during the QCL window, determining default UE power settings when not configured by active TCI state, determining an assumed TCI state when PDSCH/PUSCH is scheduled by fallback DCI without a TCI field, how to support dynamic switching between sTRP and mTRP operation, and determining a TCI state for a dynamic grant (DG)-PUSCH for sDCI. The multi-TRP unified TCI state information may also include pre-configured or pre-encoded values for default unified TCI states according to specification.

As shown, UE 101 may also, or alternatively, connect to access point (AP) 1316 via connection interface 1318, which may include an air interface enabling UE 101 to communicatively couple with AP 1316. AP 1316 may comprise a wireless local area network (WLAN), WLAN node, WLAN termination point, etc. The connection to AP 1316 may comprise a local wireless connection, such as a connection consistent with any IEEE 702.11 protocol, and AP 1316 may comprise a wireless fidelity (Wi-Fi@) router or other AP. While not explicitly depicted in FIG. 13, AP 1316 may be connected to another network (e.g., the Internet) without connecting to RAN 1320 or CN 1330. In some scenarios, UE 101, RAN 1320, and AP 1316 may be configured to utilize LTE-WLAN aggregation (LWA) techniques or LTE WLAN radio level integration with IPsec tunnel (LWIP) techniques. LWA may involve UE 101 in RRC_CONNECTED being configured by RAN 1320 to utilize radio resources of LTE and WLAN. LWIP may involve UE 101 using WLAN radio resources (e.g., connection interface 1318) via IPsec protocol tunneling to authenticate and encrypt packets (e.g., Internet Protocol (IP) packets) communicated via connection interface 1318. IPsec tunneling may include encapsulating the entirety of original IP packets and adding a new packet header, thereby protecting the original header of the IP packets.

RAN 1320 may include one or more RAN nodes 1322-1 and 1322-2 (referred to collectively as RAN nodes 1322, and individually as RAN node 1322) that enable channels 1314-1 and 1314-2 to be established between UEs 101 and RAN 1320. RAN nodes 1322 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 1322 may include a roadside unit (RSU), a transmission reception point (TRxP or TRP), and one or more other types of ground stations (e.g., terrestrial access points). In some scenarios, RAN node 1322 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 1360 may operate as bases stations (e.g., RAN nodes 1322) with respect to UEs 101. As such, references herein to a base station, RAN node 1322, etc., may involve implementations where the base station, RAN node 1322, etc., is a terrestrial network node and to implementation where the base station, RAN node 1322, etc., is a non-terrestrial network node (e.g., satellite 1360).

Some or all of RAN nodes 1322, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 1322; a media access control (MAC)/physical (PHY) layer split wherein RRC, PDCP, radio link control (RLC), and MAC layers may be operated by the CRAN/vBBUP and the PHY layer may be operated by individual RAN nodes 1322; or a “lower PHY” split wherein RRC, PDCP, RLC, MAC layers and upper portions of the PHY layer may be operated by the CRAN/vBBUP and lower portions of the PHY layer may be operated by individual RAN nodes 1322. This virtualized framework may allow freed-up processor cores of RAN nodes 1322 to perform or execute other virtualized applications.

In some implementations, an individual RAN node 1322 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 1320 or by a server pool (e.g., a group of servers configured to share resources) in a similar manner as the CRAN/vBBUP. Additionally, or alternatively, one or more of RAN nodes 1322 may be next generation eNBs (i.e., gNBs) that may provide evolved universal terrestrial radio access (E-UTRA) user plane and control plane protocol terminations toward UEs 101, and that may be connected to a 5G core network (5GC) 1330 via an NG interface.

Any of the RAN nodes 1322 may terminate an air interface protocol and may be the first point of contact for UEs 101. In some implementations, any of the RAN nodes 1322 may fulfill various logical functions for the RAN 1320 including, but not limited to, radio network controller (RNC) functions such as radio bearer management, uplink and downlink dynamic radio resource management and data packet scheduling, and mobility management. UEs 101 may be configured to communicate using orthogonal frequency-division multiplexing (OFDM) communication signals with each other or with any of the RAN nodes 1322 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 1322 to UEs 101, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 1322 may be configured to wirelessly communicate with UEs 101, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 101 and the RAN nodes 1322 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

UEs 101 may implement various techniques for communicating via a licensed and unlicensed spectrum. Examples of such techniques may include license assisted access (LAA) and NR unlicensed (NR-U), which may include anchored NR-U and standalone NR-U. The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 101 to undergo a handover.

In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 101 and the RAN nodes 1322 may also operate using the unlicensed spectrum via anchored NR-U and standalone NR-U operations, where the UE may be configured with a PCell, in addition to any SCells, in unlicensed spectrum. In anchored NR-U, UE 101 may use dual connectivity by using a licensed spectrum to communicate with an LTE anchor base station and an unlicensed spectrum to communicate with an NR-U node. Alternatively, UE 101 may use CA by using a licensed spectrum to communicate with an NR anchor base station and an unlicensed spectrum to communicate with an NR-U node. Standalone NR-U may involve a scenario in which UE 101 only communicates with the network via NR-U nodes.

The PDSCH may carry user data and higher layers signaling to UEs 101. The physical downlink control channel (PDCCH) may carry information about the transport format and resource allocations related to the PDSCH channel, among other things. The PDCCH may also inform UEs 101 about the transport format, resource allocation, and hybrid automatic repeat request (HARQ) information related to the uplink shared channel. Typically, downlink scheduling (e.g., assigning control and shared channel resource blocks to UE 101-2 within a cell) may be performed at any of the RAN nodes 1322 based on channel quality information fed back from any of UEs 101. The downlink resource assignment information may be sent on the PDCCH used for (e.g., assigned to) each of UEs 101.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as EREGs. An ECCE may have other numbers of EREGs in some situations.

The RAN nodes 1322 may be configured to communicate with one another via interface 1323. In implementations where the system is an LTE system, interface 1323 may be an X2 interface. In NR systems, interface 1323 may be an Xn interface. The X2 interface may be defined between two or more RAN nodes 1322 (e.g., two or more eNBs/gNBs or a combination thereof) that connect to evolved packet core (EPC) or CN 1330, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 101 from an SeNB for user data; information of PDCP PDUs that were not delivered to a UE 101; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 1320 may be connected (e.g., communicatively coupled) to CN 1330. CN 1330 may comprise a plurality of network elements 1332, which are configured to offer various data and telecommunications services to customers/subscribers (e.g., users of UEs 101) who are connected to the CN 1330 via the RAN 1320. In some implementations, CN 1330 may include an evolved packet core (EPC), a 5G CN, and/or one or more additional or alternative types of CNs. The components of the CN 1330 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 1330 may be referred to as a network slice, and a logical instantiation of a portion of the CN 1330 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 1330, application servers 1340, and external networks 1350 may be connected to one another via interfaces 1334, 1336, and 1338, which may include IP network interfaces. Application servers 1340 may include one or more server devices or network elements (e.g., virtual network functions (VNFs) offering applications that use IP bearer resources with CN 1330 (e.g., universal mobile telecommunications system packet services (UMTS PS) domain, LTE PS data services, etc.). Application servers 1340 may also, or alternatively, be configured to support one or more communication services (e.g., voice over IP (VoIP sessions, push-to-talk (PTT) sessions, group communication sessions, social networking services, etc.) for UEs 101 via the CN 1330. Similarly, external networks 1350 may include one or more of a variety of networks, including the Internet, thereby providing the mobile communication network and UEs 101 of the network access to a variety of additional services, information, interconnectivity, and other network features.

As shown, example network 1300 may include an NTN that may comprise one or more satellites 1360-1 and 1360-2 (collectively, “satellites 1360”). Satellites 1360 may be in communication with UEs 101 via service link or wireless interface 1362 and/or RAN 1320 via feeder links or wireless interfaces 1364 (depicted individually as 1364-1 and 1364-2). In some implementations, satellite 1360 may operate as a passive or transparent network relay node regarding communications between UE 101 and the terrestrial network (e.g., RAN 1320). In some implementations, satellite 1360 may operate as an active or regenerative network node such that satellite 1360 may operate as a base station to UEs 101 (e.g., as a gNB of RAN 1320) regarding communications between UE 101 and RAN 1320. In some implementations, satellites 1360 may communicate with one another via a direct wireless interface (e.g., 1366) or an indirect wireless interface (e.g., via RAN 1320 using interfaces 1364-1 and 1364-2).

Additionally, or alternatively, satellite 1360 may include a GEO satellite, LEO satellite, or another type of satellite. Satellite 1360 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 1360 may operate as bases stations (e.g., RAN nodes 1322) with respect to UEs 101. As such, references herein to a base station, RAN node 1322, etc., may involve implementations where the base station, RAN node 1322, etc., is a terrestrial network node and implementation, where the base station, RAN node 1322, etc., is a non-terrestrial network node (e.g., satellite 1360). As described herein, UE 101 and base station, RAN node 1322, etc., may communicate with one another, via interface 1314, to enable enhanced power saving techniques.

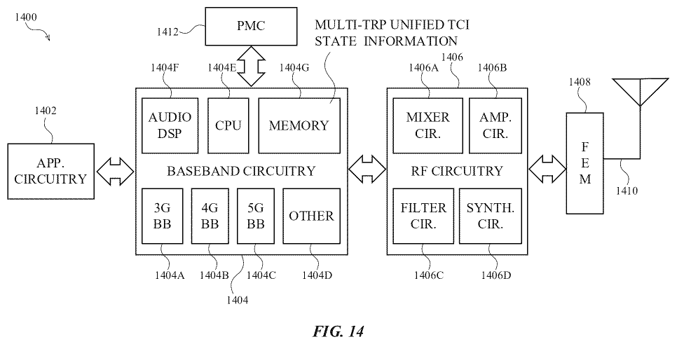

FIG. 14 is a diagram of an example of components of a device according to one or more implementations described herein. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. The components of the illustrated device 1400 can be included in a UE or a RAN node. In some implementations, the device 1400 can include fewer elements (e.g., a RAN node may not utilize application circuitry 1402, and instead include a processor/controller to process IP data received from a CN or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The application circuitry 1402 can include one or more application processors. For example, the application circuitry 1402 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1400. In some implementations, processors of application circuitry 1402 can process IP data packets received from an EPC.

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuity 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 5G, 6G, etc.). The baseband circuitry 1404 (e.g., one or more of baseband processors 1404A-D) can handle various radio control functions that enable communication with one or more radio networks via the RF circuitry 1406. In other implementations, some or all of the functionality of baseband processors 1404A-D can be included in modules stored in the memory 1404G and executed via a Central Processing Unit (CPU) 1404E.

The radio control functions can include, but are not limited to, signal modulation/demodulation, encoding/decoding, radio frequency shifting, etc. In some implementations, modulation/demodulation circuitry of the baseband circuitry 1404 can include Fast-Fourier Transform (FFT), precoding, or constellation mapping/de-mapping functionality. In some implementations, encoding/decoding circuitry of the baseband circuitry 1404 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1404G may store process multi-TRP unified TCI state information that causes the device 1400 to perform functions described above with respect to common beam management for multi-TRP operation. The multi-TRP unified TCI state information may include instructions, that when executed by a BB processor 1404C or CPU 1404E, cause the device to execute a method for determining default TCI state(s) PDSCH during the QCL window, determining default UE power settings when not configured by active TCI state, determining an assumed TCI state when PDSCH/PUSCH is scheduled by fallback DCI without a TCI field, how to support dynamic switching between sTRP and mTRP operation, and determining a TCI state for a dynamic grant (DG)-PUSCH for sDCI. The multi-TRP unified TCI state information may also include pre-configured or pre-encoded values for default unified TCI states according to specification.

In some implementations, the baseband circuitry 1404 can include one or more audio digital signal processor(s) (DSP) 1404F. The audio DSPs 1404F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1404 and the application circuitry 1402 can be implemented together such as, for example, on a system on a chip (SOC).

In some implementations, the baseband circuitry 1404 can provide for communication compatible with one or more radio technologies. For example, in some implementations, the baseband circuitry 1404 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1404 is configured to support radio communications of more than one wireless protocol can be referred to as multi-mode baseband circuitry.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. In some implementations, the transmit signal path of the RF circuitry 1406 can include filter circuitry 1406C and mixer circuitry 1406A. RF circuitry 1406 can also include synthesizer circuitry 1406D for synthesizing a frequency for use by the mixer circuitry 1406A of the receive signal path and the transmit signal path. In some implementations, the mixer circuitry 1406A of the receive signal path can be configured to down-convert RF signals received from the FEM circuitry 1408 based on the synthesized frequency provided by synthesizer circuitry 1406D. The amplifier circuitry 1406B can be configured to amplify the down-converted signals and the filter circuitry 1406C can be a low-pass filter (LPF) or band-pass filter (BPF) configured to remove unwanted signals from the down-converted signals to generate output baseband signals. Output baseband signals can be provided to the baseband circuitry 1404 for further processing. In some implementations, the output baseband signals can be zero-frequency baseband signals, although this is not a requirement. In some implementations, mixer circuitry 1406A of the receive signal path can comprise passive mixers, although the scope of the implementations is not limited in this respect.

In some implementations, the mixer circuitry 1406A of the transmit signal path can be configured to up-convert input baseband signals based on the synthesized frequency provided by the synthesizer circuitry 1406D to generate RF output signals for the FEM circuitry 1408. The baseband signals can be provided by the baseband circuitry 1404 and can be filtered by filter circuitry 1406C.

In some implementations, the mixer circuitry 1406A of the receive signal path and the mixer circuitry 1406A of the transmit signal path can include two or more mixers and can be arranged for quadrature down conversion and up conversion, respectively. In some implementations, the mixer circuitry 1406A of the receive signal path and the mixer circuitry 1406A of the transmit signal path can include two or more mixers and can be arranged for image rejection (e.g., Hartley image rejection). In some implementations, the mixer circuitry 1406A of the receive signal path and the mixer circuitry' 1406A can be arranged for direct down conversion and direct up conversion, respectively. In some implementations, the mixer circuitry 1406A of the receive signal path and the mixer circuitry 1406A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1406 can include analog-to-digital converter (ADC) and digital-to-analog converter (DAC) circuitry and the baseband circuitry 1404 can include a digital baseband interface to communicate with the RF circuitry 1406.

In some dual-mode implementations, a separate radio IC circuitry can be provided for processing signals for each spectrum, although the scope of the implementations is not limited in this respect.

In some implementations, the synthesizer circuitry 1406D can be a fractional-N synthesizer or a fractional N/N+1 synthesizer, although the scope of the implementations is not limited in this respect as other types of frequency synthesizers can be suitable. For example, synthesizer circuitry 1406D can be a delta-sigma synthesizer, a frequency multiplier, or a synthesizer comprising a phase-locked loop with a frequency divider.

The synthesizer circuitry 1406D can be configured to synthesize an output frequency for use by the mixer circuitry 1406A of the RF circuitry 1406 based on a frequency input and a divider control input. In some implementations, the synthesizer circuitry 1406D can be a fractional N/N+1 synthesizer.

In some implementations, frequency input can be provided by a voltage-controlled oscillator (VCO), although that is not a requirement. Divider control input can be provided by either the baseband circuitry 1404 or the applications circuitry 1402 depending on the desired output frequency. In some implementations, a divider control input (e.g., N) can be determined from a look-up table based on a channel indicated by the applications circuitry 1402.

Synthesizer circuitry 1406D of the RF circuitry 1406 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1406D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1406 can include an IQ/polar converter.

FEM circuitry 1408 can include a receive signal path which can include circuitry configured to operate on RF signals received from one or more antennas 1410, amplify the received signals and provide the amplified versions of the received signals to the RF circuitry 1406 for further processing. FEM circuitry 1408 can also include a transmit signal path which can include circuitry configured to amplify signals for transmission provided by the RF circuitry 1406 for transmission by one or more of the one or more antennas 1410. In various implementations, the amplification through the transmit or receive signal paths can be done solely in the RF circuitry 1406, solely in the FEM circuitry 1408, or in both the RF circuitry 1406 and the FEM circuitry 1408.

In some implementations, the FEM circuitry 1408 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1406). The transmit signal path of the FEM circuitry 1408 can include a power amplifier (PA) to amplify input RF signals (e.g., provided by RF circuitry 1406), and one or more filters to generate RF signals for subsequent transmission (e.g., by one or more of the one or more antennas 1410). The transmit and receive signal paths may include parallel components with beamforming capability to enable multi-TRP operation in which communication is performed via multiple beams at the same time.

In some implementations, the PMC 1412 can manage power provided to the baseband circuitry 1404. In particular, the PMC 1412 can control power-source selection, voltage scaling, battery charging, or DC-to-DC conversion. The PMC 1412 can often be included when the device 1400 is capable of being powered by a battery, for example, when the device is included in a UE. The PMC 1412 can increase the power conversion efficiency while providing desirable implementation size and heat dissipation characteristics.

While FIG. 14 shows the PMC 1412 coupled only with the baseband circuitry 1404. However, in other implementations, the PMC 1412 may be additionally or alternatively coupled with, and perform similar power management operations for, other components such as, but not limited to, application circuitry 1402, RF circuitry 1406, or FEM circuitry 1408.

In some implementations, the PMC 1412 can control, or otherwise be part of, various power saving mechanisms of the device 1400. For example, if the device 1400 is in an RRC_Connected state, where it is still connected to the RAN node as it expects to receive traffic shortly, then it can enter a state known as Discontinuous Reception Mode (DRX) after a period of inactivity. During this state, the device 1400 can power down for brief intervals of time and thus save power.

If there is no data traffic activity for an extended period of time, then the device 1400 can transition off to an RRC_Idle state, where it disconnects from the network and does not perform operations such as channel quality feedback, handover, etc. The device 1400 goes into a very low power state and it performs paging where again it periodically wakes up to listen to the network and then powers down again. The device 1400 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1402 and processors of the baseband circuitry 1404 can be used to execute elements of one or more instances of a protocol stack. For example, processors of the baseband circuitry 1404, alone or in combination, can be used execute Layer 3, Layer 2, or Layer 1 functionality, while processors of the baseband circuitry 1404 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. “Derive” should be construed to encompass computing or calculating the entity or value of the entity based on other quantities or entities. “Derive” should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus for a user equipment (UE), including one or more processors configured to cause the UE to receive configuration of a plurality of transmission configuration indicator (TCI) states and a unified TCI states activation/deactivation medium access control (MAC) control element (CE) to associate a plurality of TCI codepoints of a downlink control information (DCI) format to the TCI states, wherein at least two of the plurality of TCI codepoints are each mapped to two different TCI states; receive a first single downlink control information (sDCI), wherein the first sDCI includes a TCI codepoint of the plurality of TCI codepoints; receive, at a reception time, a second sDCI that schedules a PDSCH reception; and during a predetermined window after the reception time, determining one or more TCI states to be assumed for the PDSCH reception based on at least one of the plurality of TCI codepoints or a TCI state used to receive the second sDCI.

Example 2 includes the subject matter of example 1, including or omitting optional elements, wherein the first sDCI includes a TCI codepoint of the plurality of TCI codepoints that indicates two TCI states including a first TCI state and a second TCI state, and further wherein the one or more processors are configured to assume the two TCI states indicated by the TCI codepoint included in the first sDCI during the predetermined window after the reception time of the second sDCI.

Example 3 includes the subject matter of example 1, including or omitting optional elements, wherein, during the predetermined window after the reception time of the second sDCI, the one or more processors are configured to assume two TCI states indicated by a lowest TCI codepoint of the plurality of TCI codepoints that indicates two TCI states.

Example 4 includes the subject matter of example 1, including or omitting optional elements, wherein the one or more processors are configured to assume the TCI state used to receive the second sDCI during the predetermined window.

Example 5 includes the subject matter of example 4, including or omitting optional elements, wherein the TCI state used to receive the second sDCI corresponds to a monitored search space with a lowest control resource set (CORESET) in a latest slot in which CORESETs are monitored by the UE.

Example 6 includes the subject matter of example 4, including or omitting optional elements, wherein the one or more processors are configured to assume the TCI state used to receive the second sDCI during the predetermined window when a physical cell identifier (PCI) associated with the two TCI states indicated by the TCI codepoint included in the sDCI are associated with a neighbor cell that is different from a serving cell of the UE.

Example 7 includes the subject matter of example 1, including or omitting optional elements, wherein the first sDCI includes a TCI codepoint of the plurality of TCI codepoints that indicates two TCI states including a first TCI state and a second TCI state, and further wherein, during the predetermined window, the one or more processors are configured to assume one of the two TCI states indicated by the codepoint included in the first sDCI.

Example 8 includes the subject matter of example 7, including or omitting optional elements, wherein, during the predetermined window, the one or more processors are configured to assume the TCI state of the two TCI states having a smallest TCI ID.

Example 9 includes the subject matter of example 7, including or omitting optional elements, wherein, during the predetermined window, the one or more processors are configured to assume the TCI state of the two TCI states having a largest TCI ID.

Example 10 includes the subject matter of example 7, including or omitting optional elements, wherein, during the predetermined window, the one or more processors are configured to assume a TCI state of the two TCI states that is configured with quasi-co-location (QCL)-Type A/D source reference signal (RS) on a downlink (DL) bandwidth part (BWP) of a serving cell.

Example 11 includes the subject matter of example 7, including or omitting optional elements, wherein, during the predetermined window, the one or more processors are configured to assume one of the two TCI states based on higher layers signaling.

Example 12 is an apparatus of a user equipment (UE), including a memory and one or more processors configured to execute instructions stored in the memory to cause the UE to receive a configuration of one or more power control (PC) setting lists, wherein each entry in each of the PC setting lists is associated with one or more transmission reception points (TRPs); receive a configuration of a plurality of transmission configuration indicator (TCI) codepoints, each TCI codepoint indicating one or more activated uplink (UL) TCI states; receive single downlink control information (sDCI), wherein the sDCI includes a TCI codepoint of the plurality of TCI codepoints indicating two UL TCI states, each UL TCI state of the two UL TCI states being associated with one of two different transmission reception points (TRPs); and in response to one or both of the two UL TCI states not being associated with a power control setting, transmitting a PUSCH transmission based on one or more PC settings selected from the respective one or more PC setting lists.

Example 13 includes the subject matter of example 12, including or omitting optional elements, wherein each PC setting list of the one or more PC setting lists is associated with a different TRP of the two different TRPs.

Example 14 includes the subject matter of example 12, including or omitting optional elements, wherein every other entry on a single PC setting list is associated with a different TRP of the two different TRPs.

Example 15 includes the subject matter of example 12, including or omitting optional elements, wherein the one or more processors are configured to transmit the PUSCH based on the respective PC settings mapped to a PC setting list entry having a lowest index value of the respective PC settings list that is associated with each of the two different TRPs.

Example 16 includes the subject matter of example 12, including or omitting optional elements, wherein the one or more processors are configured to transmit the PUSCH based on the respective PC settings mapped to a PC setting list entry identified by an index value of the respective PC setting list, wherein the index value is pre-configured by higher layers for each of the two different TRPs.

Example 17 includes the subject matter of example 12, including or omitting optional elements, wherein the one or more processors are configured to transmit the PUSCH based on a PC settings mapped to a PC setting list entry on a PC setting list that is associated with the two different TRPs.

Example 18 includes the subject matter of example 17, including or omitting optional elements, wherein the one or more processors are configured to transmit the PUSCH based on two PC settings mapped to PC setting list entries having a lowest identifier and a second lowest identifier on the PC setting list associated with the two different TRPs.

Example 19 is an apparatus for a user equipment (UE), including one or more processors configured to receive a configuration of a plurality of transmission configuration indicator (TCI) states and a unified TCI states activation/deactivation medium access control (MAC) control element (CE) to associate TCI codepoints of a downlink control information (DCI) format to the TCI states, each TCI codepoint indicating one or more TCI states; receive a first single downlink control information (sDCI), wherein the first sDCI includes a TCI codepoint of the plurality of TCI codepoints; receive a second sDCI scheduling a PUSCH transmission or a PDSCH reception, wherein the subsequent sDCI does not include a TCI codepoint; and in response to the second sDCI, transmit the PUSCH transmission or receive the PDSCH reception based on a default uplink TCI state or a default downlink TCI state.

Example 20 includes the subject matter of example 19, including or omitting optional elements, wherein the default uplink TCI state or the default downlink TCI state is hard-encoded or predefined by specification and stored in hardware of the one or more processors of the UE.

Example 21 includes the subject matter of example 20, including or omitting optional elements, wherein the first sDCI includes a TCI codepoint of the plurality of TCI codepoints indicating two uplink TCI states or two downlink TCI states, further wherein the default uplink TCI state is predefined in the specification to be either a first TCI state or a second TCI state of the two uplink TCI states or the default downlink state is predefined in the specification to be either a first TCI state or a second TCI state the two downlink TCI states.

Example 22 includes the subject matter of example 19, including or omitting optional elements, wherein the first sDCI includes a TCI codepoint of the plurality of TCI codepoints indicating two uplink TCI states or two downlink TCI states, further wherein the default uplink TCI state or the default downlink TCI state is explicitly configured by radio resource control (RRC) signaling, a media access control (MAC) control element (CE), or a DCI as either a first TCI state or a second TCI state of the two uplink TCI states or the two downlink TCI states.

Example 23 is an apparatus for a user equipment (UE), including one or more processors configured to receive a configuration of a plurality of transmission configuration indicator (TCI) states and a unified TCI states activation/deactivation medium access control (MAC) control element (CE) to associate a plurality of TCI codepoints of a downlink control information (DCI) format to the TCI states, wherein at least two of the plurality of TCI codepoints are each mapped to two different TCI states; receive a first single downlink control information (sDCI), wherein the first sDCI includes a TCI codepoint of the plurality of TCI codepoints that indicates two TCI states including a first TCI state and a second TCI state; receive, via radio resource control (RRC) signaling, a respective configuration for physical uplink control channel (PUCCH) resource or a control resource set (CORESET) resource, and an indication of the first TCI state or the second TCI state or both the first TCI state and the second TCI state for the PUCCH resource or CORESET resource, respectively; and in response, transmit PUCCH or receive PDCCH based on the TCI states indicated by the RRC signaling.

Example 24 includes the subject matter of example 23, including or omitting optional elements, wherein the RRC configuration includes a field that encodes one of at least three values, wherein a first value corresponds to a first TCI state of the two TCI states, a second value corresponds to a second TCI state of the two TCI states, and a third value corresponds to both TCI states of the two TCI states.

Example 25 includes the subject matter of example 24, including or omitting optional elements, wherein in response to the field indicating the third value, the one or more processors enable PUCCH repetition for the PUCCH resource configured by the RRC signaling.

Example 26 includes the subject matter of example 24, including or omitting optional elements, wherein in response to the field indicating the third value, the one or more processors enable PDCCH repetition reception for the CORESET resource configured by the RRC signaling.

Example 27 includes the subject matter of example 24, including or omitting optional elements, wherein in response to the field encoding the third value, the one or more processors enable system frame number (SFN)-based PDCCH for the CORESET resource configured by the RRC signaling.

Example 28 is a method for a user equipment (UE), including receiving a configuration of a plurality of transmission configuration indicator (TCI) states and a unified TCI states activation/deactivation medium access control (MAC) control element (CE) to associate TCI codepoints of a downlink control information (DCI) format to the TCI states, each TCI codepoint indicating one or more TCI states; receiving a first single transmission reception point downlink control information (sDCI) including a TCI codepoint of the plurality of TCI codepoints; receiving a second sDCI that schedules a physical uplink shared channel (PUSCH) transmission, wherein the second sDCI indicates one or more of the TCI states associated with the TCI codepoint of the first sDCI; and in response, transmitting the PUSCH based on the second sDCI.

Example 29 includes the subject matter of example 28, including or omitting optional elements, wherein the first sDCI includes a TCI codepoint of the plurality of TCI codepoints indicating two uplink TCI states including a first TCI state and a second TCI state, wherein the second sDCI includes a field that indicates one of at least three values, wherein a first value corresponds to a first TCI state of the two uplink TCI states indicated by the first sDCI, a second value corresponds to a second TCI state of the two uplink TCI states indicated by the first sDCI, and a third value corresponds to both TCI states of the two uplink TCI states indicated by the first sDCI, the method including transmitting the PUSCH transmission based on the one or both of the two uplink TCI states indicated by the field of the second sDCI.

Example 30 includes the subject matter of example 29, including or omitting optional elements, wherein the field corresponds to dedicated bits of the second sDCI.

Example 31 includes the subject matter of example 29, including or omitting optional elements, wherein the field is a sounding reference signal (SRS) resource indicator (SRI) field of the second sDCI.

Example 32 includes the subject matter of example 28, including or omitting optional elements, including transmitting the PUSCH based on a spatial domain transmission filter associated with an SRI of a corresponding most recent SRS resource(s).

Example 33 includes the subject matter of example 29, including or omitting optional elements, wherein the spatial domain transmission filter used by the most recent SRS resource(s) is configured by a radio resource control (RRC) signaling.

Example 34 is a method that includes any action or combination of actions as substantially described herein in the Detailed Description.

Example 35 is a method as substantially described herein with reference to each or any combination of the Figures included herein or with reference to each or any combination of paragraphs in the Detailed Description.

Example 36 is a user equipment configured to perform any action or combination of actions as substantially described herein in the Detailed Description as included in the user equipment.

Example 37 is a network node configured to perform any action or combination of actions as substantially described herein in the Detailed Description as included in the network node.

Example 38 is a non-transitory computer-readable medium that stores instructions that, when executed, cause the performance of any action or combination of actions as substantially described herein in the Detailed Description.

Example 39 is an apparatus for a user equipment including a memory and one or processors that execute instructions stored in the memory cause the UE to perform of any action or combination of actions as substantially described herein in the Detailed Description.

Example 40 is an apparatus for a network node one or processors that execute instructions stored in the memory cause the network node to perform of any action or combination of actions as substantially described herein in the Detailed Description.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-33. (canceled)

34. A baseband processor configured to, when executing instructions stored in a memory, perform operations comprising:
receiving configuration of a plurality of transmission configuration indicator (TCI) states and a plurality of TCI codepoints associated with the TCI states, each TCI codepoint indicating one or more TCI states;
receiving a first single transmission reception point downlink control information (sDCI) indicating a TCI codepoint of the plurality of TCI codepoints;
receiving a second sDCI that schedules a physical uplink shared channel (PUSCH) transmission, wherein the second sDCI indicates a particular TCI state associated with the TCI codepoint indicated by the first sDCI; and
in response, causing transmission of the PUSCH transmission based on the particular TCI state.

35. The baseband processor of claim 34, wherein the first sDCI indicates a TCI codepoint of the plurality of TCI codepoints that indicates two uplink TCI states including a first TCI state and a second TCI state, wherein the second sDCI includes a field that indicates one of at least three values, the operations comprising causing transmission of the PUSCH based on the one or both of the two uplink TCI states indicated by the field of the second sDCI.

36. The baseband processor of claim 35, wherein a first value of the at least three values corresponds to a first TCI state of the two uplink TCI states indicated by the first sDCI, a second value of the at least three values corresponds to a second TCI state of the two uplink TCI states indicated by the first sDCI, and a third value of the at least three values corresponds to both TCI states of the two uplink TCI states indicated by the first sDCI.

37. The baseband processor of claim 35, wherein the field corresponds to dedicated bits of the second sDCI.

38. The baseband processor of claim 35, wherein the field is a sounding reference signal (SRS) resource indicator (SRI) field of the second sDCI.

39. The baseband processor of claim 34, wherein the operations comprise causing transmission of the PUSCH based on a spatial domain transmission filter associated with an SRI of a corresponding most recent SRS resource(s).

40. The baseband processor of claim 39, wherein the spatial domain transmission filter used by the most recent SRS resource(s) is configured by a radio resource control (RRC) signaling.

41. A user equipment (UE), comprising:
a memory; and
one or more processors configured to execute instructions stored in the memory to cause the UE to
receive a configuration of one or more power control (PC) setting lists, wherein each entry in each of the PC setting lists is associated with one or more transmission reception points (TRPs);
receive a configuration of a plurality of transmission configuration indicator (TCI) codepoints, each TCI codepoint indicating one or more activated uplink (UL) TCI states;
receive single transmission reception point downlink control information (sDCI), wherein the sDCI indicates a TCI codepoint of the plurality of TCI codepoints that indicates two UL TCI states, each UL TCI state of the two UL TCI states being associated with one of two different transmission reception points (TRPs); and
in response to one or both of the two UL TCI states not being associated with a power control setting, transmit a PUSCH transmission based on one or more PC settings selected from the respective one or more PC setting lists.

42. The UE of claim 41, wherein each PC setting list of the one or more PC setting lists is associated with a different TRP of the two different TRPs.

43. The UE of claim 41 wherein every other entry on a single PC setting list is associated with a different TRP of the two different TRPs.

44. The UE of claim 41, wherein the one or more processors are configured to cause the UE to transmit the PUSCH based on the respective PC settings mapped to a PC setting list entry having a lowest index value of the respective PC settings list that is associated with each of the two different TRPs.

45. The UE of claim 41, wherein the one or more processors are configured to cause the UE to transmit the PUSCH based on the respective PC settings mapped to a PC setting list entry identified by an index value of the respective PC setting list, wherein the index value is pre-configured by higher layers for each of the two different TRPs.

46. The UE of claim 41, wherein the one or more processors are configured to cause the UE to transmit the PUSCH based on a PC settings mapped to a PC setting list entry on a PC setting list that is associated with the two different TRPs.

47. The UE of claim 41, wherein the one or more processors are configured to cause the UE to transmit the PUSCH based on two PC settings mapped to PC setting list entries having a lowest identifier and a second lowest identifier on the PC setting list associated with the two different TRPs.

48. The UE of claim 47, wherein the PC setting mapped to the lowest identifier is used for a first TRP of the two different TRPs and the PC setting mapped to the second lowest identifier is used for a second TRP of the two different TRPs.

49. A user equipment (UE), comprising a memory and one or more processors configured to, when executing instructions stored in the memory, cause the UE to:
receive configuration of a plurality of transmission configuration indicator (TCI) states and a plurality of TCI codepoints associated with the TCI states, each TCI codepoint indicating one or more TCI states;
receive a first single downlink control information (sDCI), wherein the first sDCI indicates a TCI codepoint of the plurality of TCI codepoints;
receive a second sDCI scheduling a PUSCH transmission or a PDSCH reception, wherein the subsequent sDCI does not indicate a TCI codepoint; and
in response to the second sDCI, transmit the PUSCH transmission based on a default uplink TCI state or receive the PDSCH reception based on a default downlink TCI state.

50. The UE of claim 49 wherein the default uplink TCI state or the default downlink TCI state is hard-encoded or predefined by specification and stored in hardware of the one or more processors of the UE.

51. The UE of claim 50, wherein the first sDCI indicates a TCI codepoint of the plurality of TCI codepoints indicating two uplink TCI states or two downlink TCI states, further wherein the default uplink TCI state is predefined in the specification to be either a first TCI state or a second TCI state of the two uplink TCI states or the default downlink state is predefined in the specification to be either a first TCI state or a second TCI state the two downlink TCI states.

52. The UE of claim 49, wherein the first sDCI indicates a TCI codepoint of the plurality of TCI codepoints indicating two uplink TCI states or two downlink TCI states, further wherein the default uplink TCI state or the default downlink TCI state is explicitly configured by radio resource control (RRC) signaling as either a first TCI state or a second TCI state of the two uplink TCI states or the two downlink TCI states.

53. The UE of claim 49, wherein the first sDCI indicates a TCI codepoint of the plurality of TCI codepoints indicating two uplink TCI states or two downlink TCI states, further wherein the default uplink TCI state or the default downlink TCI state is explicitly configured by a media access control (MAC) control element (CE) or a DCI as either a first TCI state or a second TCI state of the two uplink TCI states or the two downlink TCI states.
